(19) United States
(12) Patent Application Publication
(10) Pub. No.: US 2007/0107768 A1
(43) Pub. Date: May 17, 2007

(54) Solar Power System

(76) Inventors: Jagjit S. Romana, Canton, MI (US); Rajwinder K. Romana, Canton, MI (US)

Correspondence Address: ADVANTIA LAW GROUP, 9035 SOUTH 1300 EAST, SUITE 200, SANDY, UT, 84094, US

(21) Appl. No.: 11/552,349

(22) Filed: Oct. 24, 2006

Related U.S. Application Data
(60) Provisional application No. 60/737,424, filed on Nov. 16, 2005.

(51) Int. Cl. H02N 6/00

(52) U.S. Cl. 136/244

(57) ABSTRACT

A solar power system for providing electricity to a vehicle. The system includes a motor vehicle, having: a battery, a roof, a front window, and a hood; a rectangular roof solar panel module disposed on the roof and in electrical communication with the battery; and a rectangular windshield solar panel module pivotally coupled to the roof solar panel module, disposable over the front windshield, and in electrical communication with the battery. Additionally, the system includes: a rectangular hood solar panel module pivotally coupled to the windshield solar panel module, disposable over the hood, and in electrical communication with a high capacity battery pack.

### BACKGROUND OF THE INVENTION

This invention claims priority, under 35 U.S.C. § 120, to the U.S. Provisional Patent Application No. 60/737,424 to U.S. Patent and Trademark Office, filed on Nov. 17, 2005, which is incorporated by reference herein.

### FIELD OF THE INVENTION

The present invention relates to solar power systems, specifically solar power system for providing electricity to motor vehicles.

### DESCRIPTION OF THE RELATED ART

In the related art, it has been known to use solar power systems to provide additional electrical power to electric vehicles or the like. Traditionally manufactured automobiles have batteries that are rechargeable for a limited amount of time before having to purchase a new battery. In addition, the process of recharging a dead battery is time-consuming and inconvenient. Further, recharging batteries during daylight hours can significantly increase the cost of electricity as a result of increasing peak demand charges from the utility to the consumer. Some improvements have been made in the field. Examples include but are not limited to the references described below, which references are incorporated by reference herein:

U.S. Pat. No. 5,680,907, issued to Weihe, discloses an automobile having a primary engine fueled by a primary source of fossil fuel energy, the primary engine and an auxiliary motor device are drivably connected to one or more ground engagement wheels of the automobile. A solar energy collecting device is mounted on the automobile for exposure to solar energy, and has an energy supply mechanism that routes energy collected by the solar energy collecting device to the auxiliary motor device. A control mechanism operates so that either energy is routed from the energy supply device to the auxiliary motor device, or energy is prevented from being routed to the auxiliary motor device.

U.S. Pat. No. 6,586,668, issued to Shugar et al., discloses a photovoltaic (PV) roof assembly includes a roof mountable to an electric vehicle, and a PV assembly at the upper part of the roof. The PV assembly may be mounted to a separate roof surface or the PV assembly may itself constitute all or part of the roof. The vehicle may include a secondary PV assembly coupled to a display unit to provide an independent indication of the intensity of solar irradiation. The roof may have mounting element recesses to accommodate mounting elements of the PV assembly, the mounting elements configured so as not to shade the PV panel. The roof may also be configured to accommodate a global positioning device. The roof preferably includes a peripheral gutter. The roof body preferably includes hand-hold recesses housing hand-hold elements at positions to provide a horizontal setback from the lateral sides of the roof body.

U.S. Pat. No. 6,423,894, issued to Patz et al., discloses a motor vehicle roof with a solar generator which is securely attached on the outside on the solid roof skin for producing solar current for the vehicle. The solar generator can be adjusted between a first spatially compact configuration and a second, less spatially compact configuration in which its active solar surface projected onto the plane of the roof is larger than in the first configuration. The invention also relates to a motor vehicle roof with an attachment element which runs in the lengthwise direction of the roof and which is mounted externally on the solid roof skin and which is made such that a mobile flat solar generator can be pushed into the attachment element and is held in the working configuration by it to produce solar current.

U.S. Pat. No. 4,592,436, issued to Tomei, discloses a solar powered vehicle utilizing incident solar radiation to charge storage batteries for energizing an electric motor mounted within the vehicle. The solar panel module comprises a lower panel mounted on an exterior surface of the vehicle and first and second upper panels pivotally connected on opposed sides to the lower panel and movable between a first inboard position overlaying the lower panel and a second outboard position in-line with the lower panel in which the lower panel and the first and second upper panels are disposed for receiving incident solar radiation. The first and second upper panels are releasably interlockable with the lower panel in a secure, spaced-apart position when the first and second upper panels are disposed in the first inboard position overlying the lower panel. A plurality of solar panel modules may be provided on the roof, hood and/or trunk of the vehicle.

U.S. patent application Publication No.: 2004/0040755, by Swindell et al., discloses an improved battery powered four wheel multi-speed all electric motor car, used to move personnel and powered by two multi-wound electric motors connected in tandem so that by engaging the controls three speeds may be achieved. The forward and reverse of the vehicle is accomplished by moving a forward and reverse switch before staring the vehicle by engaging the operating switch. The electrical supply for the vehicle is furnished by batteries charged by a standby rectifier when vehicle is not in use and with solar panel module and fuel cell interfacing during daytime operation and the quick removable batteries and hydrogen tanks at exchange stations, if desired by the operator of the vehicle, adds to the uniqueness of our invention by adding to the art of unlimited speed and distance. The interchangeable system of the batteries and the hydrogen tanks on travel routes and the ease which these components can be installed, removed from and replaced in our motor car adds to the many aptitudes of this motor car and to its uniqueness.

U.S. Design Pat. No.: D390,501, issued to Kranz, discloses the ornamental design for a solar-powered electric vehicle.

The inventions heretofore known suffer from a number of disadvantages which include being inconvenient, heavy, impractical, cost of manufacture, failing to take advantage of available surface area of a vehicle, etc.

What is needed is a solar power system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available solar power systems. Accordingly, the present invention has been developed to provide a solar power system for providing electricity to motor vehicles.

In one embodiment of the present invention, there is a solar power system for providing electricity to a vehicle. The system may include: a motor vehicle that may have a battery; and/or a roof; an/or a front window; and/or a hood; a rectangular roof solar panel module that may be disposed on the roof and/or may be in electrical communication with the battery; and a rectangular windshield solar panel module that may be pivotally coupled to the roof solar panel module, and/or may be disposable over the front windshield, and/or may be in electrical communication with the battery.

According to one embodiment, the solar power system may also include: a rectangular hood solar panel module that may be pivotally coupled to the windshield solar panel module, and/or may be disposable over the hood, and/or may be in electrical communication with the battery. The battery may be in the form of a high capacity battery pack.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top perspective view of a solar power system, according to one embodiment;

FIG. 2 is a front elevational view of a solar power system, according to one embodiment; and

FIG. 3 is a block diagram of a solar power system, according to one embodiment.

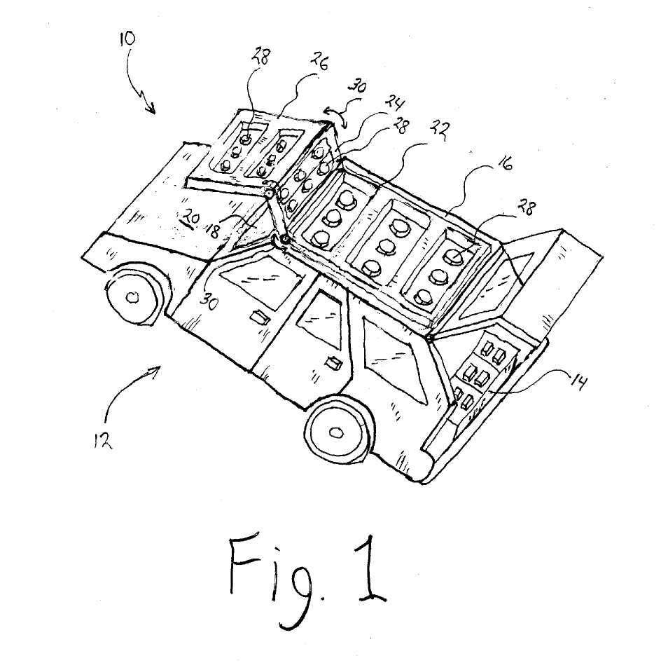

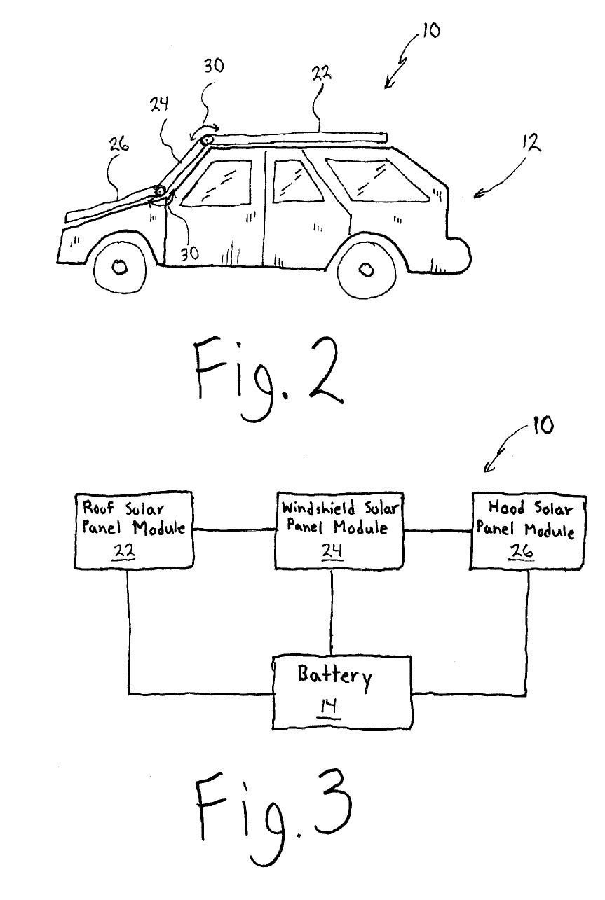

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Looking to the figures, there is an illustrated embodiment of a solar power system 10 for providing electricity to hybrid, and electric-powered motor vehicles. The system, as shown, includes: a motor vehicle 12 having: a battery 14; a roof 16; a front window 18; and a hood 20; a rectangular roof solar panel module 22, disposed on the roof and is in electrical communication with the battery; and a rectangular windshield solar panel module 24 pivotally coupled to the roof solar panel module, as indicated by arrow 30, and is disposable over the front windshield of the vehicle, and is in electrical communication with the battery.

According to one embodiment, the illustrated solar power system also include: a rectangular hood solar panel module 26, pivotally coupled to the windshield solar panel module 24, as indicated by arrow 30, and is disposable over the hood, and is in electrical communication with the battery 14 (also referred to as a high capacity battery pack). The solar modules 22, 24, 26, each have a plurality of cylindrical-shaped photovoltaic cells 28 disposed therein. A non-limiting example of solar modules 22, 24, 26 is described in U.S. Pat. No. 6,586,668 issued to Shugar et al., which is incorporated by reference herein.

In operation, the user can use insulated wiring and hardware, such as bolts, locking mechanisms, etc. to: removably mount the roof solar panel module 22 to the vehicle roof 16; removably mount the windshield solar panel module 24 to the vehicle front window 18; and removably mount the hood solar panel module 26 to the vehicle hood 20. Thus, the panel modules 22, 24, 26 are positioned in such a manner to cover the parked vehicle's roof, front window, and hood. The user then could connect the electrical output plug from each of the panel modules into the vehicle's high capacity battery pack 14, thereby allowing solar radiation generated by the sun to be emitted into solar panel modules 22, 24, 26. The thermo energy from sunlight is absorbed by the photovoltaic cells 28 disposed in the panel modules and is converted into electrical power and stored in the battery 14 which is ultimately used to provide additional electrical power to vehicles 12 having internal combustion engines and electrically-powered motors, and other accessories such as radio, compact disc players, windshield wipers, headlights, etc.

According to another embodiment of the present invention, the solar modules 22, 24, 26 may be part of the roof structure of a motor vehicle 12.

According to yet another embodiment of the present invention, the solar modules 22, 24, 26 may be built into segments to span windows, rear glass, windshield, hood, doors, side panels etc) of the vehicle exposed directly or indirectly to sunlight.

According to still yet another embodiment of the present invention, the solar power system 10 may include an additional battery 14 to increase storage capacity. House power supply units may be used to charge the battery 14 during hours of darkness, while solar energy may be stored in same battery 14 when vehicle is driven during hours of daylight and is parked outside in sun. Both plug-in and solar systems utilize the same battery 14 to store power at different time and help to optimize the battery size.

As a result, the solar power system 10 adds extra battery-charging capabilities to parked or driven vehicles; reduces fuel consumption and emission; and improves fuel economy for a user's vehicle. Instead of relying exclusively upon the engine-driven generator and regenerative braking to charge the battery, this system would provide extra battery charging whether the vehicle is parked or in operation. This capability helps ensure that the battery has sufficient electric potential vehicle as intended. In addition, the system would help improve existing hybrid technology by reducing engine exhaust emissions, boosting fuel economy, and saving motorist money at the gasoline pumps.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Although the figure illustrates the solar modules 22, 24, 26 having cylindrical-shaped photovoltaic cells 28 disposed therein, one skilled in the art would know that the cells may be shaped different, according to various embodiments. For example: planar, cubical, rectangular, triangular, etc.

Additionally, although the figures illustrate the solar power system being employed on a van, one skilled in the art that the system may be constructed for application to other motor vehicle types. For example, cars, trucks, etc.

It is expected that there could be numerous variations of the design of this invention. For example, the roof solar panel module 22; windshield solar panel module 24; and/or hood solar panel 26 may vary in length, width, size, etc. to accommodate various dimensions with respect to the motor vehicle 12, roof 16, front window 18, hood, etc.

It is envisioned that the battery 14 may vary in size, length, width, volume, shape, configuration, etc. to accommodate different sizes and types of motor vehicles 12, according to various embodiments.

Finally, it is also envisioned that the components of the device may be constructed of a variety of materials, such as metals, metal alloys, composite material, plastics, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A solar power system for providing electricity to a vehicle, comprising:
a motor vehicle having:
a battery;
a roof;
a front window; and
a hood;
a roof solar panel module disposed on the roof and in electrical communication with the battery; and
a windshield solar panel module pivotally coupled to the roof solar panel module, disposable over the front windshield, and in electrical communication with the battery.

2. The solar power system of claim 1, further comprising a hood solar panel module pivotally coupled to the windshield solar panel module, disposable over the hood, and in electrical communication with the battery.

3. The solar power system of claim 2, wherein the battery is a high capacity battery pack.

4. The solar power system of claim 3, wherein each of the roof solar panel module, the windshield solar panel module, and the hood solar panel module are rectangular.

5. A solar power system for providing electricity to a vehicle, consisting essentially of:
a motor vehicle, having:
a battery;
a roof;
a front window; and
a hood;
a roof solar panel module disposed on the roof and in electrical communication with the battery;
a windshield solar panel module pivotally coupled to the roof solar panel module, disposable over the front windshield, and in electrical communication with the battery; and
a hood solar panel module pivotally coupled to the windshield solar panel module, disposable over the hood, and in electrical communication with the battery.

6. The solar power system of claim 5, wherein the battery is a high capacity battery pack.

7. The solar power system of claim 6, wherein each of the roof solar panel module, the windshield solar panel module, and the hood solar panel module are rectangular.
